(19) United States
(12) Patent Application Publication
(10) Pub. No.: US 2025/0069134 A1
(43) Pub. Date: Feb. 27, 2025

(54) TRANSPORTATION SERVICE PROVISION WITH A VEHICLE FLEET

(71) Applicant: Uber Technologies, Inc., San Francisco, CA (US)

(72) Inventors: Prateek Jain, Santa Clara, CA (US); Kevin G. Babcock, Boulder, CO (US); Samantha Wan-Jou Lin, San Francisco, CA (US)

(21) Appl. No.: 18/813,707

(22) Filed: Aug. 23, 2024

Related U.S. Application Data
(60) Provisional application No. 63/589,615, filed on Oct. 11, 2023.
(60) Provisional application No. 63/583,562, filed on Sep. 18, 2023.
(60) Provisional application No. 63/578,653, filed on Aug. 24, 2023.

(51) Int. Cl. G06Q 30/08; G01C 21/34

(52) U.S. Cl. CPC G06Q 30/08; G01C 21/34

(57) ABSTRACT

An autonomous vehicle (AV) system is described. The AV system receives a request for a transportation service associated with pickup and drop off (PUDO) locations. The AV system, in response to receiving the request, transmits data representing the PUDO locations to an AV service provider and receives a proposed navigation plan, for an AV, that includes the PUDO locations. The AV system determines whether the proposed navigation plan received from the AV service provider satisfies one or more trip quality criteria. The AV system selectively transmits an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.

### CROSS-REFERENCE TO RELATED APPLICATIONS

This application is a non-provisional of and claims priority to U.S. Provisional Application No. 63/578,653, filed Aug. 24, 2023; U.S. Provisional Application No. 63/583,562, filed Sep. 18, 2023; and U.S. Provisional Application No. 63/589,615, filed Oct. 11, 2023, each of which is hereby incorporated by reference in its entirety.

### BACKGROUND

An autonomous vehicle (AV) is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for managing a mixed fleet of vehicles using a service assignment system.

FIG. 2 depicts a block diagram of an example vehicle according to example aspects of the present disclosure.

FIG. 3 is a block diagram showing one example of the service assignment system, according to some examples.

FIG. 4 illustrates a routine 400 in accordance with some examples.

FIG. 5 is a block diagram showing one example of a software architecture for a computing device.

FIG. 6 is a diagrammatic representation of a machine in the form of a computer system within which a set of instructions may be executed for causing the machine to perform any one or more of the methodologies discussed herein, according to an example.

### DESCRIPTION

Examples described herein are directed to systems and methods for using a computing system to manage and/or operate a fleet of vehicles to execute transportation services, where the fleet includes autonomous vehicles (AVs).

In an autonomous or semi-autonomous vehicle (collectively referred to as an AV), a vehicle autonomy system, sometimes referred to as an AV stack, controls one or more of braking, steering, or throttle of the vehicle. In a fully autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input. Some autonomous vehicles can also operate in a manual mode, in which a human user provides all control inputs to the vehicle.

In some examples, a service assignment system receives requests for transportation services from one or more users. A transportation service may include transporting a payload, such as cargo (or tangible items) and/or one or more passengers (riders), from a service start location to a service end location. Examples of cargo can include tangible items, such as food, packages, and/or the like. The service assignment system may match received transportation service requests from users with vehicles from the mixed fleet. When the service assignment system selects a vehicle for a requested transportation service, it may instruct the vehicle to begin executing the requested transportation service.

Specifically, existing ride-hailing systems (also referred to as transportation services systems) often waste resources through an inefficient process of sending offers to autonomous vehicles (AVs) for trips (transportation requests) that ultimately fail to meet certain quality criteria, leading to unnecessary rejections. This approach creates several issues that compound to reduce overall system efficiency. The process usually begins with the system generating and transmitting offers to AV providers without first verifying if the trip (transportation request) meets specific quality standards and without verifying if the AV can actually perform the requested service. This results in computational overhead as processing power and bandwidth are expended on potentially unsuitable matches. The time spent waiting for responses from AV providers on these unsuitable trips introduces increased latency and potentially frustrating riders awaiting confirmation.

In addition, each rejected offer typically involves one or more application programming interface (API) calls to the AV provider, consuming valuable resources and potentially incurring costs. The constant back-and-forth of sending offers and receiving rejections creates unnecessary traffic within the system and potentially slowing down other important operations. While the system is occupied with processing these AV offers that are likely to fail to meet quality standards, it may miss opportunities to quickly match the transportation requests with more suitable transportation options. Additionally, each rejected offer generates data that may be logged, stored, and potentially analyzed, creating an additional burden on the system's data management infrastructure. By failing to pre-screen trips against AV-specific quality criteria before sending offers, these systems create a cascade of inefficiencies that waste both computational and human resources, ultimately degrading the service quality for riders and reducing the overall effectiveness of the ride-hailing platform.

The disclosed techniques address these technical problems by implementing a pre-offer check (POC) mechanism in the offer generation system of the service assignment system. In this technical solution, when the service assignment system receives a transportation service request, it transmits the pickup and drop-off (PUDO) locations to the AV service provider. The AV provider then returns a proposed navigation plan for an autonomous vehicle. The service assignment system then evaluates this plan against predefined trip quality criteria before making an offer. Only if the plan satisfies these criteria does the system transmit an offer to the AV provider, including the PUDO locations and relevant service quality information. This approach eliminates the inefficiencies of sending unsuitable offers, thereby reducing computational overhead, latency, and unnecessary API calls. By pre-screening trips against AV-specific quality standards, the disclosed techniques streamline the matching process, improve system efficiency, and enhance overall service quality for ride-hailing platforms incorporating AVs.

The disclosed techniques further address the technical problems by providing a rejection reason segmentation system as part of the service assignment system. The rejection reason segmentation system enables the AV to provide data that can be used to determine a reason that the AV is unable to accept an offer and is unable to perform the transportation service within the specified quality criteria. Using this reason, the service assignment system can determine whether to send further offers to the AV fleet that includes the AV or to exclude the AV fleet in its entirety from receiving further offers for the same transportation service request. Specifically, the service assignment system can determine whether the reason for rejecting the offer is specific to the AV or is applicable to the AV fleet as a whole. In this way, if the service assignment system relaxes some of the service quality criteria to generate further offers, the service assignment system can determine whether or not to expend additional resources to send the further offers to the same AV fleet or not. This further improves the overall operations of the system and increases efficiency and reduces waste of resources.

In some examples, the service assignment system receives a request for a transportation service associated with PUDO locations. The service assignment system, in response to receiving the request, transmits data representing the PUDO locations to an AV service provider. The service assignment system receives, from the AV service provider, a proposed navigation plan, for an AV, that includes the PUDO locations. The service assignment system determines whether the proposed navigation plan received from the AV service provider satisfies one or more trip quality criteria and selectively transmits an offer to the AV service provider to perform the transportation service in response to determining whether the proposed navigation plan received from the AV service provider satisfies the one or more trip quality criteria, with the offer including the PUDO locations and service quality information corresponding to the one or more trip quality criteria. In some cases, the data is transmitted as part of a POC operation, wherein the AV service provider attempts to generate a route for completing the transportation service based on the service quality information. The service assignment system can receive, from the AV service provider, data indicating whether the AV service provider accepts or rejects the offer.

In some examples, the service assignment system receives a rejection of the offer from the AV service provider in response to the AV service provider being unsuccessful in generating the route for completing the transportation service. The service assignment system processes data associated with the rejection to infer a reason for the rejection of the offer. The service assignment system can receive, from the AV service provider, a reason for rejection of the offer.

In some cases, the service assignment system determines whether the transportation service corresponds to mobility of a rider or delivery of an item and selectively transmits one or more further offers for completing the transportation service based on determining whether the transportation service corresponds to the mobility of the rider or the delivery of the item. In some examples, the AV service provider selects the reason for rejecting the offer from a plurality of available reasons provided by the service assignment system. The plurality of available reasons can including any one or more of: an operational design domain indicating lack of capability by the AV to complete the transportation service; a change in a state associated with the AV between a time that the data was transmitted to the AV service provider and a time when the offer was transmitted to the AV service provider; a malfunction of the AV; an estimated time of arrival (ETA) of the AV at one of the PUDO locations exceeding an expected ETA by more than a threshold duration; an estimated time of departure (ETD) of the AV exceeding a threshold; a distance between a pickup or drop off location of the route exceeding a pickup or drop off location requested by the transportation service by more than a threshold distance; out of service area for the AV; end time of the route exceeding operating hours of the AV; and unsupported weather or road conditions. The service assignment system categorizes the reason for the rejection as being applicable to a fleet of AVs or specific to an AV in a fleet of AVs of the AV service provider.

In some examples, the service assignment system determines that the reason for rejection is applicable to the fleet of AVs associated with the AV service provider; and preventing transmission of one or more further offers for completing the transportation service to the AV service provider. In some cases, the service assignment system selects an alternate AV service provider and transmits the one or more further offers to the alternate service provider in response to determining that the reason for rejection is applicable to the fleet of AVs associated with the AV service provider. In some cases, the service assignment system determines that the reason for rejection is specific to an AV in the fleet of AVs of the AV service provider and, in response to determining that the reason for rejection is specific to the AV in the fleet of AVs of the AV service provider, transmits one or more further offers to the AV service provider, the one or more further offers having a revised set of the one or more trip quality criteria for completing the transportation service.

In some examples, the service assignment system receives an acceptance of the offer from the AV service provider in response to the AV service provider successfully generating the route (also referred to as a navigation plan) for completing the transportation service. The service assignment system checks the route, generated by the AV service provider, to ensure the route satisfies the one or more trip quality criteria.

The data representing the PUDO locations can include a requested pickup location and a requested drop off location. In such cases, the service assignment system computes a first deviation of distance between the requested pickup location and a proposed pickup location in the proposed navigation plan and computes a second deviation of duration between an expected estimated time of arrival (ETA) at the requested pickup location and a proposed ETA at the requested pickup location in the proposed navigation plan. The service assignment system computes a third deviation of distance between the requested drop off location and a proposed drop off location in the proposed navigation plan and computes a fourth deviation of duration between an expected ETA at the drop off location and a proposed ETA at the drop off location in the proposed navigation plan. The service assignment system determines that the one or more trip quality criteria is satisfied in response to determining that the first deviation and the third deviation fail to transgress a maximum distance threshold and in response to determining that the second deviation and the fourth deviation fail to transgress a maximum duration threshold.

The service quality information can correspond to the one or more trip quality criteria included in the offer, including an expected estimated time of arrival (ETA) at a requested pickup location and an expected ETA at a drop off location. The service quality information can include a first maximum distance threshold between the requested pickup location and a pickup location in a route performed by the AV. The service quality information can include a second maximum distance threshold between the requested drop off location and a drop off location in the route performed by the AV. In some cases, the service assignment system applies a first set of filters to a collection of vehicles including one or more AVs prior to transmitting the data representing the PUDO locations to the AV service provider.

In some examples, the service assignment system prevents transmission of the offer to the AV service provider in response to determining that the proposed navigation plan received from the AV service provider fails to satisfy the one or more trip quality criteria. The service assignment system can obtain a profile associated with a rider corresponding to the request and predict whether the rider is likely to accept transportation services from the AV based on the profile. The service assignment system selectively transmits the offer in response to the predicting of whether the rider is likely to accept transportation services from the AV.

One or more of the methodologies described herein facilitate solving the technical problem of sending offers/requests for AVs to complete a transportation service or transportation service request with conventional methods. As such, one or more of the methodologies described herein obviate a need for certain efforts or computing resources that otherwise would be involved in completing transactions and also enable a greater marketplace and match efficiency between riders/users and vehicles for transport. As a result, resources used by one or more machines, databases, or devices (e.g., within the environment) are reduced. Examples of such computing resources include processor cycles, network traffic, memory usage, data storage capacity, power consumption, network bandwidth, and cooling capacity.

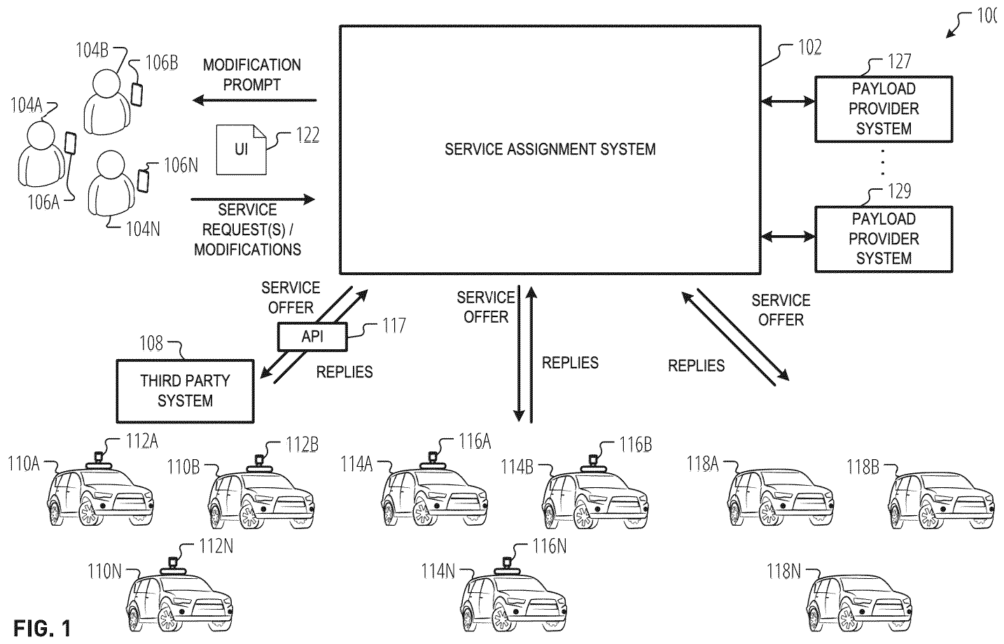

FIG. 1 is a diagram showing one example of an environment 100 for managing a mixed fleet of vehicles using a service assignment system 102. The environment 100 includes the service assignment system 102, a fleet of vehicles 110A, 110B, 110N, 114A, 114B, 114N, 118A, 118B, 118N, and users 104A, 104B, 104N (also referred to as one or more requestors). The fleet of vehicles may be a mixed fleet including AVs and human-driven vehicles. In this example, the fleet includes AVs 110A, 110B, 110N, 114A, 114B, 114N and human-driven vehicles 118A, 118B, 118N. Some or all of the vehicles 110A, 110B, 110N, 114A, 114B, 114N, 118A, 118B, 118N may be passenger vehicles, such as passenger trucks, cars, buses, or other similar vehicles. Also, some or all of the vehicles 110A, 110B, 110N, 114A, 114B, 114N, 118A, 118B, 118N may be delivery vehicles, such as vans, delivery trucks, tractor trailers, and so forth.

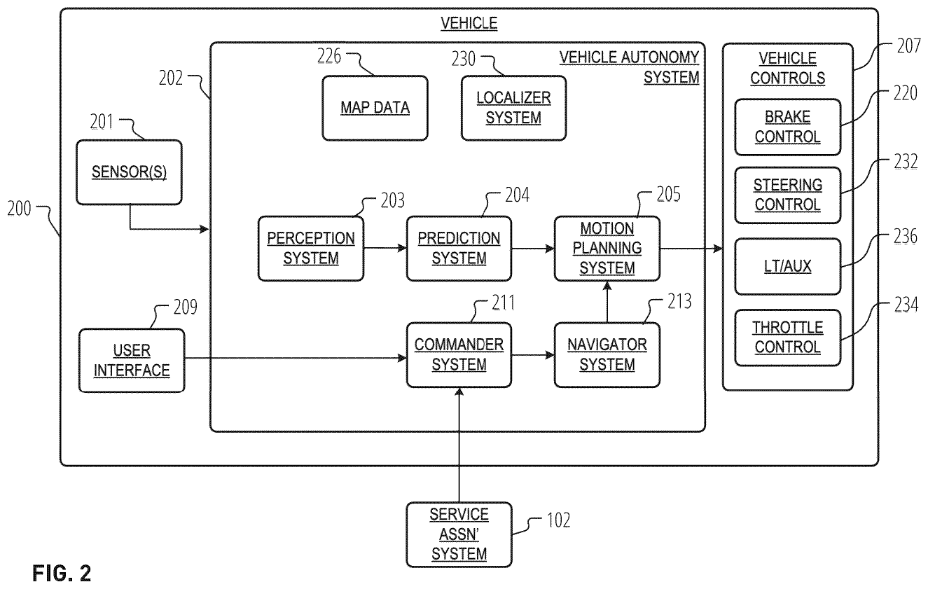

In this example, the AVs 110A, 110B, 110N, 114A, 114B, 114N include respective vehicle autonomy systems, described in more detail with respect to FIG. 2. The vehicle autonomy systems are configured to operate some or all of the controls (e.g., acceleration, braking, steering) of the AVs 110A, 110B, 110N, 114A, 114B, 114N. In some examples, one or more of the AVs 110A, 110B, 110N, 114A, 114B, 114N are operable in different modes, where the vehicle autonomy system has differing levels of control over the AV 110A, 110B, 110N, 114A, 114B, 114N. Some AVs 110A, 110B, 110N, 114A, 114B, 114N may be operable in a fully autonomous mode in which the vehicle autonomy system has responsibility for all or most of the controls of the AV 110A, 110B, 110N, 114A, 114B, 114N. Some AVs 110A, 110B, 110N, 114A, 114B, 114N are operable in a semiautonomous mode that is in addition to or instead of the fully autonomous mode. In a semiautonomous mode, the vehicle autonomy system of an AV 110A, 110B, 110N, 114A, 114B, 114N is responsible for some of the vehicle controls while a human user or driver is responsible for other vehicle controls. In some examples, one or more of the AVs 110A, 110B, 110N, 114A, 114B, 114N are operable in a manual mode in which the human user is responsible for all controls of the AV 110A, 110B, 110N, 114A, 114B, 114N.

The AVs 110A, 110B, 110N, 114A, 114B, 114N include one or more respective remote-detection sensor sets 112A, 112B, 112N, 116A, 116B, 116N. The remote-detection sensor sets 112A, 112B, 112N, 116A, 116B, 116N include one or more remote-detection sensors that receive signals from the environment 100. The signals may be emitted by and/or reflected from objects in the environment 100, such as the ground, buildings, trees, and so forth. The remote-detection sensor sets 112A, 112B, 112N, 116A, 116B, 116N may include one or more active sensors, such as light imaging detection and ranging (LIDAR) sensors, radio detection and ranging (RADAR) sensors, and/or sound navigation and ranging (SONAR) sensors, that emit sound or electromagnetic radiation in the form of light or radio waves to generate return signals. Information about the environment 100 is extracted from the received signals. In some examples, the remote-detection sensor sets 112A, 112B, 112N, 116A, 116B, 116N include one or more passive sensors that receive signals that originated from other sources of sound or electromagnetic radiation. The remote-detection sensor sets 112A, 112B, 112N, 116A, 116B, 116N provide remote-detection sensor data that describes the environment 100. The AVs 110A, 110B, 110N, 114A, 114B, 114N can also include other types of sensors, for example, as described in more detail with respect to FIG. 2.

In some examples, the AVs 110A, 110B, 110N, 114A, 114B, 114N are of different types. Different types of AVs may have different capabilities. For example, the different types of AVs 110A, 110B, 110N, 114A, 114B, 114N can have different vehicle autonomy systems. This can include, for example, vehicle autonomy systems made by different manufacturers or designers, vehicle autonomy systems having different software versions or revisions, and so forth. Also, in some examples, the different types of AVs 110A, 110B, 110N, 114A, 114B, 114N can have different remote-detection sensor sets 112A, 112B, 112N, 116A, 116B, 116N. For example, one type of AV 110A, 110B, 110N, 114A, 114B, 114N may include a LIDAR remote-detection sensor, while another type may include stereoscopic cameras and omit a LIDAR remote-detection sensor. In some examples, different types of AVs 110A, 110B, 110N, 114A, 114B, 114N can also have different mechanical particulars. For example, one type of vehicle may have all-wheel drive, while another type may have front-wheel drive, and so forth.

In the example of FIG. 1, the AVs 110A, 110B, 110N are managed by a third-party system 108. The third-party system 108 (also referred to as AV service provider(s) 316) may be implemented by an entity that manages or otherwise operates the AVs 110A, 110B, 110N. The collection of all the AVs 110A, 110B, 110N managed by the third-party system 108 is known as a fleet of AVs. There can be multiple third-party system 108 each associated with a respective fleet of AVs.

For example, service offers offering a transportation service to the AVs 110A, 110B, 110N may be directed from the service assignment system 102 to the third-party system 108. The third-party system 108 may communicate the service offers to the respective AVs 110A, 110B, 110N. Replies to service offers (e.g., messages accepting and/or declining (rejecting) an offered transportation service) may be sent from the third-party system 108 to the service assignment system 102. In some examples, the third-party system 108 may accept and/or decline a service offer on behalf of the AVs 110A, 110B, 110N. Although one third-party system 108 and associated AVs 110A, 110B, 110N are shown in FIG. 1, it will be appreciated that other examples of the environment 100 may include multiple third-party systems and associated AVs.

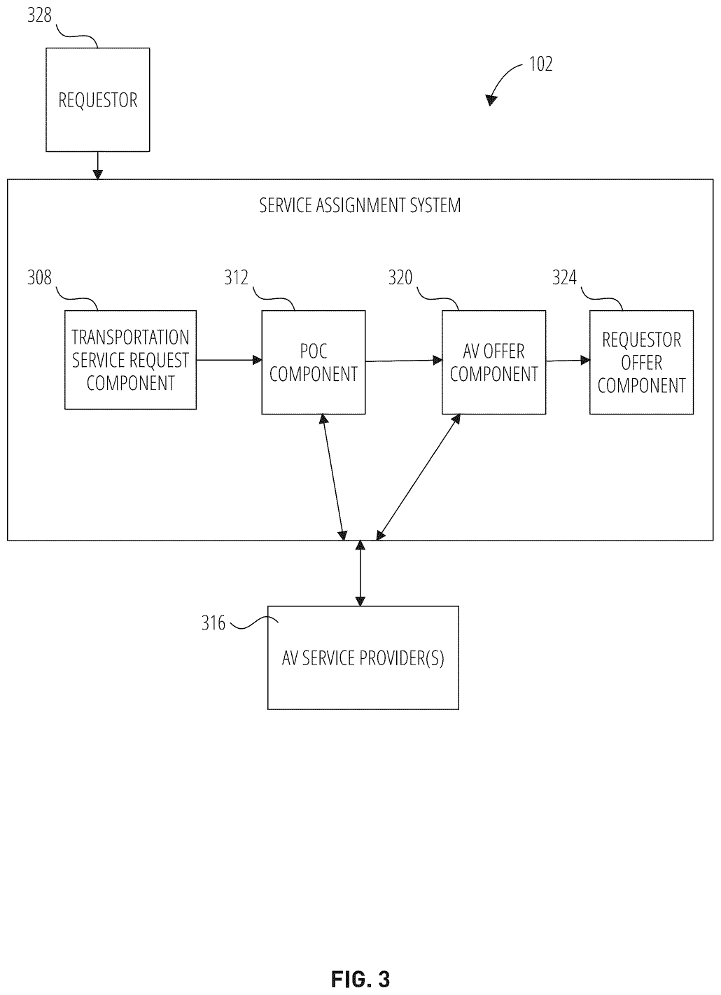

As discussed below in connection with FIG. 3, the third-party system 108 can respond to pre-offer checks (POC) provided by the service assignment system 102. The service assignment system 102 can then condition sending the actual offers for transportation services to the third-party system 108 based on the result of the POCs. In some cases, the POC can exclude service quality criteria and can only specify a set of potential PUDO locations. Once the service assignment system 102 decides that the third-party system 108 is eligible to receive an offer based on a potential navigation path received from the third-party system 108 responsive to the POC, the service assignment system 102 can send the actual offer to the third-party system 108. The actual offer can include the same or more specific sets of PUDO locations and service quality criteria that needs to be met by the AV of the third-party system 108 in performing the transportation service request or transportation service. If the third-party system 108 is unable to find/generate a route for one or more AVs in the fleet managed by the third-party system 108 that can complete the transportation service within the parameters of the service quality criteria, the third-party system 108 can send a rejection back to the service assignment system 102. The rejection can include data specifying the reasons for the rejection or can include some other information that the service assignment system 102 can use to infer the reasons for rejection.

If the third-party system 108 is able to find/generate a route for one or more AVs in the fleet managed by the third-party system 108 that can complete the transportation service within the parameters of the service quality criteria, the third-party system 108 can send an acceptance back to the service assignment system 102. The service assignment system 102 can evaluate the acceptance which can include details about the route (e.g., the ETA at the pickup location, a distance between the pickup location and a pickup location of the rider/item, the ETA at the drop off location, a distance between the drop off location and a drop off location specified in the transportation service request) against one or more criteria to select the AV to perform the transportation service.

In some examples, communication between the service assignment system 102 and one or more third-party systems 108 is performed by an application programming interface (API) such as API 117. For example, service offers (including one or more POCs) from the service assignment system 102 to one or more of the AVs 110A, 110B, 110N (or the third-party system 108) can be performed using one or more calls by the service assignment system 102 and/or by the third-party system 108 to the API 117. Similarly, replies from the third-party system 108 to the service assignment system 102 may involve one or more calls to the API 117 by the third-party system 108 or the service assignment system 102. For example, the third-party system 108 may reply to a service offer by accepting the offer or declining (rejecting) the offer including reasons for rejecting the offer. The third-party system 108 can respond to a POC by providing a proposed navigation path that includes proposed ETA at the proposed pickup location of the proposed transportation service provided by the service assignment system 102, proposed ETA at the proposed drop off location of the proposed transportation service provided by the service assignment system 102, and distances to each of the proposed PUDO locations and actual PUDO locations of the AV. Also, although a single API 117 is shown in FIG. 1, it will be appreciated that some arrangements may include multiple APIs for managing communications between the third-party system 108 and the service assignment system 102. For example, different APIs may be used for different communication tasks.

In some examples, the service assignment system 102 may communicate directly with AVs 114A, 114B, 114N (e.g., not through a third-party system 108). For example, the service assignment system 102 may provide service offers and receive replies directly to AVs 114A, 114B, 114N. The AVs 114A, 114B, 114N with which the service assignment system 102 communicates directly may be operated and/or managed by a third-party and/or by the entity implementing the service assignment system 102.

In the example of FIG. 1, the service assignment system 102 also communicates with human-driven vehicles 118A, 118B, 118N, for example, to provide service offers and receive replies. The service assignment system 102 may communicate with the vehicles 118A, 118B, 118N themselves (e.g., through an infotainment system or other suitable computing system of the vehicle) and/or with one or more of the human drivers of the vehicles 118A, 118B, 118N (e.g., via a user computing device or devices of the human drivers). It will be appreciated that FIG. 1 shows just one example of a mixed fleet and that different mixed fleets may have different numbers and proportions of AVs and human-driven vehicles.

The service assignment system 102 is programmed to receive service requests from the users 104A, 104B, 104N and offer requested transportation services to vehicles selected from the fleet of vehicles 110A, 110B, 110N, 114A, 114B, 114N, 118A, 118B, 118N as described herein. The service assignment system 102 can be or include one or more servers or other suitable computing devices. The service assignment system 102 is configured to receive transportation service requests from one or more users 104A, 104B, 104N. The users 104A, 104B, 104N make transportation service requests with remote-detection sensor sets 106A, 106B, 106N. The remote-detection sensor sets 106A, 106B, 106N can be or include any suitable computing device such as, for example, tablet computers, mobile telephone devices, laptop computers, desktop computers, and so forth. In some examples, the remote-detection sensor sets 106A, 106B, 106N execute an application associated with a transportation service implemented with the service assignment system 102. The users 104A, 104B, 104N launch the application on the respective remote-detection sensor sets 106A, 106B, 106N and utilize functionality of the application to make transportation service requests.

The service assignment system 102 is programmed to receive and process transportation service requests from users 104A, 104B, 104N. Upon receiving a transportation service request, the service assignment system 102 may filter the fleet of vehicles 110A, 110B, 110N, 114A, 114B, 114N, 118A, 118B, 118N to select a set of one or more candidate vehicles. The candidate vehicles may include vehicles that are suitable, or potentially suitable, for executing the requested transportation service. From the set of candidate vehicles, the service assignment system 102 may select a vehicle or vehicles to which the requested transportation service will be offered. The service assignment system 102 may select the vehicle or vehicles based on any suitable criterion or criteria such as, for example, vehicle locations, vehicle cost to execute the requested transportation service, a prior acceptance rate of the vehicle and/or of vehicles of the same type, and so forth. In some examples, the service assignment system 102 selects a vehicle or vehicles to offer a transportation service using a route for the transportation service, which may be generated by the service assignment system 102, by the third-party system 108, and/or by any other suitable component of the environment 100.

The service assignment system 102 may select the candidate vehicles based on various criteria such as, for example, the availability of the various vehicles in the fleet, properties of the service request, user preferences, and/or the like. Properties of the service request may include, for example, the service start location, the service end location, the type of payload (e.g., size and weight of payload, number of passengers, and so forth).

In some examples, the service assignment system 102 provides a user interface 122 (UI) to the users 104A, 104B, 104N via the respective remote-detection sensor sets 106A, 106B, 106N. The UI 122 may provide functionality allowing the users to make service requests for transportation services. For example, the UI 122 may include fields in which a user 104A, 104B, 104N can provide request properties such as, for example, a service start location, a service end location, a description of the desired payload, and/or the like.

In some examples, a user 104A, 104B, 104N may request a transportation service that involves the delivery of a product, where the product is all or part of the payload of the transportation service. For example, a user 104A, 104B, 104N may request delivery of a meal from a restaurant or other provider or a delivery of a purchase from a store or other provider. In some examples, the service assignment system 102 is in communication with one or more payload provider systems 127, 129. Payload provider systems 127, 129 are associated with restaurants, stores, or other entities that provide payloads for transportation services, for example, where the payloads are delivered to the service end location.

In some examples, the UI 122 includes information about payload that can be provided by a payload provider system 127, 129. Consider an example in which a transportation service is to deliver prepared food via a payload provider system 127, 129. The UI 122 may include fields allowing the user 104A, 104B to select the payload provider system 127, 129 and/or items from the menu of the payload provider system 127, 129 for delivery. The properties of the service request, then, can include the identified payload. When a vehicle accepts the requested transportation service, the service assignment system 102 may provide an instruction to the selected payload provider system 127, 129 requesting preparation of the payload and providing information about the vehicle that will pick up the payload for delivery.

The example environment 100 describes a mixed fleet including AVs 110A, 110B, 110N managed by the third-party system 108, AVs, AVs managed by the service assignment system 102 and human-driven vehicles 118A, 118B, 118N. It will be appreciated, however, that in various examples, the environment 100 may include more or fewer different types of vehicles. For example, in some arrangements, the service assignment system 102 may offer transportation services to multiple third-party fleets of autonomous vehicles via multiple third-party systems (e.g., and multiple APIs or API instances). In other examples, some or all of the vehicle types shown in the environment 100 be omitted. For example, the service assignment system 102 may be configured to offer service assignments only to autonomous vehicles or only to autonomous vehicles managed by third-party systems, or permutations thereof.

FIG. 2 depicts a block diagram of an example vehicle 200 according to example aspects of the present disclosure. The vehicle 200 shows one example arrangement of one of the AVs 110A, 110B, 110N, 114A, 114B, 114N of FIG. 1. The vehicle 200 includes one or more sensors 201, a vehicle autonomy system 202, and one or more vehicle controls 207. The vehicle 200 is an autonomous vehicle, as described herein. The example vehicle 200 shows just one example arrangement of an autonomous vehicle. In some examples, autonomous vehicles of different types can have different arrangements.

The vehicle autonomy system 202 includes a commander system 211, a navigator system 213, a perception system 203, a prediction system 204, a motion planning system 205, and a localizer system 230 that cooperate to perceive the surrounding environment of the vehicle 200 and determine a motion plan for controlling the motion of the vehicle 200 accordingly.

The vehicle autonomy system 202 is engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate route through the environment. The vehicle autonomy system 202 sends commands to control the one or more vehicle controls 207 to operate the vehicle 200 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data includes information that describes the location of objects within the surrounding environment of the vehicle 200, information that describes the motion of the vehicle 200, and so forth.

The sensors 201 may also include one or more remote-detection sensors or sensor systems, such as a LIDAR system, a RADAR system, one or more cameras, and so forth. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system measures distances by measuring the Time of Flight (TOF) that it takes a short laser pulse to travel from the sensor to an object and back and calculates the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system reflect off an object and return to a receiver of the RADAR system, giving information about the object's location and speed. Thus, a RADAR system provides useful information about the current speed of an object.

As yet another example, one or more cameras of the one or more sensors 201 may generate sensor data (e.g., remote-detection sensor data) including still or moving images. Various processing techniques (e.g., range imaging techniques such as structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system determines a current position of the vehicle 200. The positioning system can be any device or circuitry for analyzing the position of the vehicle 200. For example, the positioning system can determine a position by using one or more of inertial sensors, a satellite positioning system such as the Global Positioning System (GPS), a positioning system based on IP address, triangulation and/or proximity to network access points or other network components (e.g., cellular towers, Wi-Fi access points), and/or other suitable techniques. The position of the vehicle 200 can be used by various systems of the vehicle autonomy system 202.

Thus, the one or more sensors 201 are used to collect sensor data that includes information that describes the location (e.g., in three-dimensional space relative to the vehicle 200) of points that correspond to objects within the surrounding environment of the vehicle 200. In some implementations, the sensors 201 can be positioned at different locations on the vehicle 200. As an example, in some implementations, one or more cameras and/or LIDAR sensors can be located in a pod or other structure that is mounted on a roof of the vehicle 200, while one or more RADAR sensors can be located in or behind the front and/or rear bumper(s) or body panel(s) of the vehicle 200. As another example, one or more cameras can be located at the front or rear bumper(s) of the vehicle 200. Other locations can be used as well.

The localizer system 230 receives some or all of the sensor data from the sensors 201 and generates vehicle poses for the vehicle 200. A vehicle pose describes a position and attitude of the vehicle 200. The vehicle pose (or portions thereof) can be used by various other components of the vehicle autonomy system 202 including, for example, the perception system 203, the prediction system 204, the motion planning system 205, and the navigator system 213.

The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates vehicle poses by comparing sensor data (e.g., remote-detection sensor data) to map data 226 describing the surrounding environment of the vehicle 200.

In some examples, the localizer system 230 includes one or more pose estimators and a pose filter. Pose estimators generate pose estimates by comparing remote-detection sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 are provided to various other components of the vehicle autonomy system 202. For example, the commander system 211 may utilize a vehicle position to determine whether to respond to a call from a service assignment system 102.

The commander system 211 determines a set of one or more target locations that are used for routing the vehicle 200. The target locations are determined based on user input received via a user interface 209 of the vehicle 200. The user interface 209 may include and/or use any suitable input/output device or devices. In some examples, the commander system 211 determines the one or more target locations using data received from the service assignment system 102. The service assignment system 102 is programmed to provide instructions to multiple vehicles, for example, as part of a fleet of vehicles for moving passengers and/or cargo. Data from the service assignment system 102 can be provided via a wireless network, for example.

The navigator system 213 receives one or more target locations from the commander system 211 and map data 226. The map data 226, for example, provides detailed information about the surrounding environment of the vehicle 200. The map data 226 provides information regarding identity and location of different roadways and roadway elements. A roadway is a place where the vehicle 200 can drive and may include, for example, a road, a street, a highway, a lane, a parking lot, or a driveway. Routing graph data is a type of map data 226.

From the one or more target locations and the map data 226, the navigator system 213 generates route data describing a route for the vehicle 200 to take to arrive at the one or more target locations. In some implementations, the navigator system 213 determines route data using one or more path-planning algorithms based on costs for graph elements/corresponding roadway elements, as described herein. For example, a cost for a route can indicate a time of travel, risk of danger, or other factor associated with adhering to a particular proposed route. Route data describing a route is provided to the motion planning system 205, which commands the vehicle controls 207 to implement the route or route extension, as described herein. The navigator system 213 can generate routes as described herein using a general-purpose routing graph and routing graph modification data. Also, in examples where route data is received from the service assignment system 102, that route data can also be provided to the motion planning system 205.

The perception system 203 detects objects in the surrounding environment of the vehicle 200 based on sensor 201 data, the map data 226, and/or vehicle poses provided by the localizer system 230. For example, the map data 226 used by the perception system 203 describes roadways and segments thereof and may also describe buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 200. State data describes a current state of an object (also referred to as features of the object). The state data for each object describes, for example, an estimate of the object's current location (also referred to as position); current speed (also referred to as velocity); current acceleration; current heading; current orientation; size/shape/footprint (e.g., as represented by a bounding shape such as a bounding polygon or polyhedron); type/class (e.g., vehicle, pedestrian, bicycle, or other); yaw rate; distance from the vehicle 200; minimum path to interaction with the vehicle 200; minimum time duration to interaction with the vehicle 200; and/or other state information.

In some implementations, the perception system 203 determines state data for each object over a number of iterations. In particular, the perception system 203 updates the state data for each object at each iteration. Thus, the perception system 203 detects and tracks objects, such as other vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 generates prediction data associated with one or more of the objects detected by the perception system 203. In some examples, the prediction system 204 generates prediction data describing each of the respective objects detected by the perception system 203.

Prediction data for an object is indicative of one or more predicted future locations of the object. For example, the prediction system 204 may predict where the object will be located within the next 5 seconds, 30 seconds, 200 seconds, and so forth. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left turn for the vehicle such that the vehicle turns left at the intersection. Similarly, the prediction system 204 determines predicted trajectories for other objects, such as bicycles, pedestrians, parked vehicles, and so forth. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 commands the vehicle controls 207 based at least in part on the predicted trajectories associated with the objects within the surrounding environment of the vehicle 200, the state data for the objects provided by the perception system 203, vehicle poses provided by the localizer system 230, the map data 226, and route or route extension data provided by the navigator system 213. Stated differently, given information about the current locations of objects and/or predicted trajectories of objects within the surrounding environment of the vehicle 200, the motion planning system 205 determines control commands for the vehicle 200 that best navigate the vehicle 200 along the route or route extension relative to the objects at such locations and their predicted trajectories on acceptable roadways.

In some implementations, the motion planning system 205 can also evaluate one or more cost functions and/or one or more reward functions for each of one or more candidate control commands or sets of control commands for the vehicle 200. Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate control command or set of control commands. The motion planning system 205 can select or determine a control command or set of control commands for the vehicle 200 based at least in part on the cost function(s) and the reward function(s). For example, the motion plan that minimizes the total cost can be selected or otherwise determined.

In some implementations, the motion planning system 205 can be configured to iteratively update the route or route extension for the vehicle 200 as new sensor data is obtained from the one or more sensors 201. For example, as new sensor data is obtained from the one or more sensors 201, the sensor data can be analyzed by the perception system 203, the prediction system 204, and the motion planning system 205 to determine the motion plan.

The motion planning system 205 can provide control commands to the one or more vehicle controls 207. For example, the one or more vehicle controls 207 can include throttle systems, brake systems, steering systems, and other control systems, each of which can include various vehicle controls (e.g., actuators or other devices that control gas flow, steering, and braking) to control the motion of the vehicle 200. The various vehicle controls 207 can include one or more controllers, control devices, motors, and/or processors.

The vehicle controls 207 include a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 200. The secondary system may be configured to determine a failure of the primary system to brake the vehicle 200 in response to receiving the braking command.

A steering control system 232 is configured to receive a steering command and bring about a response in the steering mechanism of the vehicle 200. The steering command is provided to a steering system to provide a steering input to steer the vehicle 200.

A lighting/auxiliary control module 236 receives a lighting or auxiliary command. In response, the lighting/auxiliary control module 236 controls a lighting and/or auxiliary system of the vehicle 200. Controlling a lighting system may include, for example, turning on, turning off, or otherwise modulating headlights, parking lights, running lights, etc. Controlling an auxiliary system may include, for example, modulating windshield wipers, a defroster, etc.

A throttle control system 234 is configured to receive a throttle command and bring about a response in the engine speed or other throttle mechanism of the vehicle. For example, the throttle control system 234 can instruct an engine and/or engine controller, or other propulsion system component, to control the engine or other propulsion system of the vehicle 200 to accelerate, decelerate, or remain at its current speed.

Each of the perception system 203, the prediction system 204, the motion planning system 205, the commander system 211, the navigator system 213, and the localizer system 230 can be included in or otherwise be a part of the vehicle autonomy system 202 configured to control the vehicle 200 based at least in part on data obtained from the one or more sensors 201. For example, data obtained by the one or more sensors 201 can be analyzed by each of the perception system 203, the prediction system 204, and the motion planning system 205 in a consecutive fashion in order to control the vehicle 200. While FIG. 2 depicts elements suitable for use in a vehicle autonomy system according to example aspects of the present disclosure, one of ordinary skill in the art will recognize that other vehicle autonomy systems can be configured to control an autonomous vehicle based on sensor data.

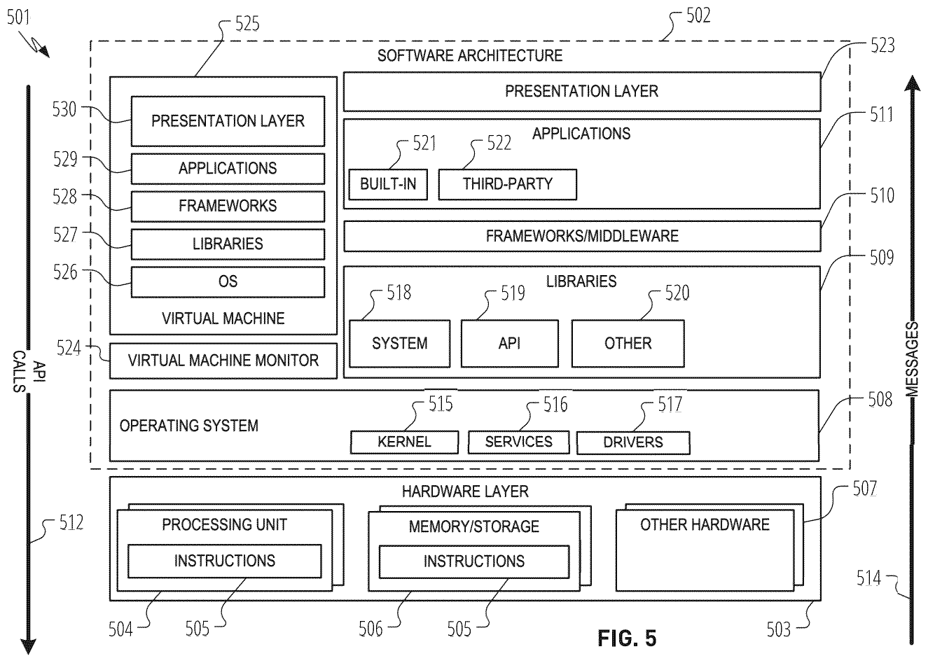

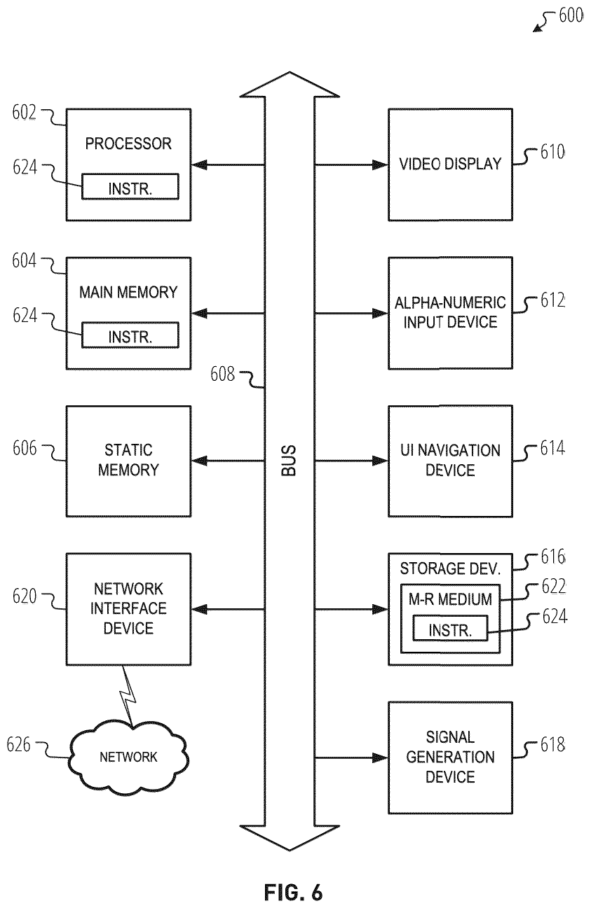

The vehicle autonomy system 202 includes one or more computing devices, which may implement all or parts of the perception system 203, the prediction system 204, the motion planning system 205, and/or the localizer system 230. Descriptions of hardware and software configurations for computing devices to implement the vehicle autonomy system 202 and/or the service assignment system 102 of FIG. 1 are provided herein with reference to FIG. 5 and FIG. 6.

FIG. 3 is a block diagram showing one example of the service assignment system 102, according to some examples. The service assignment system 102 includes a transportation service request component 308, a POC component 312, an AV offer component 320, and a requestor offer component 324. The service assignment system 102 can be coupled to a user interface 122 through which a requestor 328 generates one or more transportation services requests including or specifying one or more PUDO locations. The transportation services requests can include a request associated with mobility where the requestor 328 is transported from one physical location to another or delivery where a tangible item is delivered to the physical location of the requestor 328 from another physical location.

The transportation service request component 308 can communicate with the requestor 328 via a user interface 122. In response to the transportation service request component 308 receiving a request for the transportation service from the requestor 328, the transportation service request component 308 can perform a set of operations to find a suitable vehicle (e.g., an AV) to perform the requested transportation service. In some cases, the transportation service request component 308 can perform initial processing of parameters of the transportation service to filter a wide range of vehicles or AVs to a smaller subset. This initial filtering can be performed based on distance between the PUDO locations of the requestor 328 and current vehicle positions, ratings of the requestor 328 and/or drivers 517, and/or preferences of the requestor 328 along with any other suitable criteria.

After the transportation service request component 308 generates a subset of vehicles that may be used to perform the requested transportation service, the transportation service request component 308 can communicate the PUDO locations of the transportation service to the POC component 312. The POC component 312 can be configured to identify a subset of AV fleets and/or AV service provider(s) 316 that can perform the transportation service request by communicating some information about the PUDO locations to the AV service provider(s) 316.

Specifically, the POC component 312 can generate a simulated or conditional offer that includes some information about the transportation service request. For example, the POC component 312 can specify GPS coordinates of a requested pickup location and GPS coordinates of a requested drop off location. The POC component 312 communicates the simulated or conditional offer to the AV service provider(s) 316. In response, the AV service provider(s) 316 can analyze one or more AVs in the fleet of AVs managed by the AV service provider(s) 316 to generate a proposed navigation plan that includes the requested pickup location and the requested drop off location. In some cases, the POC component 312 can itself check locations, parameters and resources of various AV service provider(s) 316 and/or different AVs and can select one or more AVs to which to send the conditional offer. The proposed navigation plan (or route) can include the ETA of the requested pickup location, a proposed pickup location, the ETA of the requested drop off location, and/or a proposed drop off location, and/or an estimated time of duration for the AV to reach the proposed pickup location from a start time. The proposed navigation plan can include any other suitable information.

The AV service provider(s) 316 provides the proposed navigation plan to the POC component 312. The POC component 312 can then determine whether the proposed navigation plan received from the AV service provider(s) 316 satisfies one or more trip quality criteria. For example, the one or more trip quality criteria can include various measures of maximum distances between the requested PUDO locations and/or the proposed PUDO locations and maximum durations between requested PUDO location ETAs and ETAs of the proposed PUDO locations. Specifically, the POC component 312 can compute a first deviation of distance between the requested pickup location and a proposed pickup location in the proposed navigation plan. The POC component 312 can compute a second deviation of duration between an expected ETA at the requested pickup location and a proposed ETA at the requested pickup location in the proposed navigation plan. The POC component 312 can compute a third deviation of distance between the requested drop off location and a proposed drop off location in the proposed navigation plan. The POC component 312 can compute a fourth deviation of duration between an expected ETA at the drop off location and a proposed ETA at the drop off location in the proposed navigation plan. The POC component 312 can then determine whether any or all of the trip quality criteria is satisfied or met. If so, the POC component 312 adds the AV service provider(s) 316 to a list of possible AVs to which an offer for the transportation service request can be sent. For example, the POC component 312 can determine that the one or more trip quality criteria is satisfied in response to determining that the first deviation and the third deviation fail to transgress a maximum distance threshold and in response to determining that the second deviation and the fourth deviation fail to transgress a maximum duration threshold.

The POC component 312 provides the candidate list of AVs (or the selected set of AVs determined by the POC component 312) to which the offer can be submitted to the AV offer component 320. The AV offer component 320 can then generate an offer for submission to one of the AVs in the candidate list of AVs. The AV offer component 320 generates an offer that includes the actual waypoints or GPS coordinates specified in the request for the transportation service along with service quality information that corresponds to or is derived from the one or more trip quality criteria. The service quality information can include an expected estimated time of arrival (ETA) at a requested pickup location and an expected ETA at a drop off location, a first maximum distance threshold between the requested pickup location and a pickup location in a route performed by the AV, and/or a second maximum distance threshold between the requested drop off location and a drop off location in the route performed by the AV corresponding to the one or more trip quality criteria. The AV offer component 320 provides or sends that offer to the AV service provider(s) 316. The AV service provider(s) 316 can attempt to generate a route that includes the actual waypoints or GPS coordinates specified in the request for the transportation service and that satisfies the one or more trip quality criteria. The AV service provider(s) 316 can generate either an acceptance or rejection of the offer based on the ability of the AV service provider(s) 316 to generate the route that satisfies the one or more trip quality criteria. In some cases, if the AV offer component 320 does not select a particular AV service provider(s) 316 to perform the transportation service, the AV offer component 320 can provide a general response to the AV service provider(s) 316 to let the AV service provider(s) 316 know that it has failed with specific criteria. This response may not provide the exact threshold/failure value that caused the failure of satisfying the trip criteria but instead can be the overall category so that the AV service provider(s) 316 can diagnose issues.

In some cases, the AV service provider(s) 316 simply sends a rejection message to the AV offer component 320 without specifying any reason for the rejection. The AV offer component 320 can then analyze various other information associated with the rejection to infer the reasons for the rejection. The AV offer component 320 can generate additional offers and send the additional offers to other vehicles or AVs in an attempt to find a suitable vehicle to complete the requested transportation service request. If no suitable vehicle can be found, the AV offer component 320 can revise or relax the trip quality criteria and resubmit offers with the relaxed trip quality criteria to the AV service provider(s) 316 and/or other vehicles until a vehicle is found. In some cases, the AV offer component 320 conditions sending these further offers or additional offers on the basis of the reason(s) that the original offer was rejected by the AV service provider(s) 316.

For example, the AV service provider(s) 316 can generate a rejection message that includes reasons for rejecting the offer. The AV service provider(s) 316 can obtain a list of available rejections from the service assignment system 102 and can select a reason from the list. In some cases, the AV service provider(s) 316 generates a custom reason if a corresponding or matching reason is not found in the list. In some examples the available reasons include any one or more of: an operational design domain indicating lack of capability by the AV to complete the transportation service; a change in a state associated with the AV between a time that the data was transmitted to the AV service provider and a time when the offer was transmitted to the AV service provider; a malfunction of the AV; an estimated time of arrival (ETA) of the AV at one of the PUDO locations exceeds an expected ETA by more than a threshold duration; an estimated time of departure (ETD) of the AV exceeds a threshold; a distance between a pickup or drop off location of the route exceeds a pickup or drop off location requested by the transportation service by more than a threshold distance; out of service area for the AV; end time of the route exceeds operating hours of the AV; and unsupported weather or road conditions.

Specifically, the reasons can indicate the rejection is related to the operational design domain. Some examples of where this may be the case include the vehicle autonomy cannot support a capability needed for job/route, the job/route segment(s) is out of geofence/not mapped, the job will bring vehicle outside of temporal operational bounds (e.g., cannot operate past 12 PM), current weather/road conditions not being supported, and/or the segment(s) of normally supported route are currently not available. The reasons can indicate the rejection is due to a state change that did not have time to propagate to service assignment system 102. Examples include the vehicle was about to pause and become non-dispatchable and the vehicle was about to go offline. The reasons can indicate the rejection is because the vehicle's ETA is much later than the ETA requested in the transportation request. The reasons can indicate that the rejection is because the vehicle's ETD, calculated as the sum of pickup time and trip time, is much later than ETD or that the rejection is due to the AV's planned pickup location is significantly (more than a threshold distance) farther away from the rider's pickup location. Or that the rejection is due to the AV's planned drop-off location being significantly farther away from the rider's dropoff location. The rejection reason can indicate that the rejection is due to the capability limitations of the autonomous vehicle for this job/route, such as limited sensor range in dense urban environment, limited hardware to handle the unique traffic patterns, and/or limited network connectivity. The rejection can indicate that the rejection is due to job/route segment(s) out of the service area or that the job would end after the vehicle's operating hours (e.g., the vehicle cannot operate past midnight) or due to an unsupported weather condition or road condition or due to insufficient batter/fuel to complete the job/route.

The service assignment system 102 can categorize the reasons received from the AV service provider(s) 316 into being applicable to the fleet of AVs associated with the AV service provider(s) 316 or being applicable to the specific AV of the AV service provider(s) 316. If the reason is associated with the entire fleet of AVs of the AV service provider(s) 316, the service assignment system 102 can send further or additional offers to a different AV service provider(s) 316 associated with a different fleet of AVs. If the reason is specific to a particular AV, the AV service provider(s) 316 can send further or additional offers to the same AV service provider(s) 316 in case a different AV is able to meet the relaxed trip quality criteria.

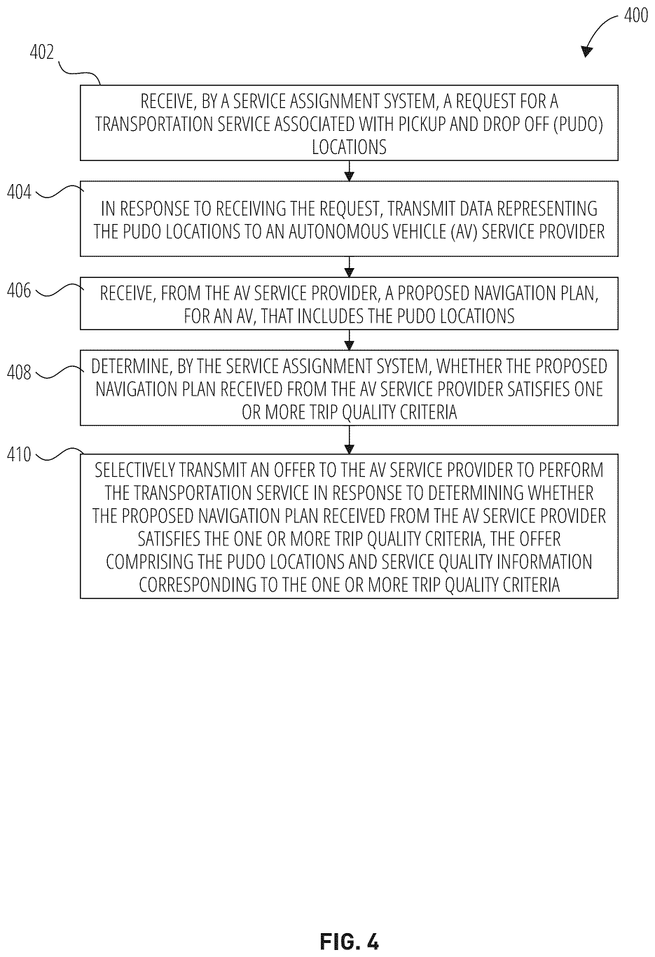

FIG. 4 illustrates a routine 400 (method or process) in accordance with some examples. The operations discussed in connection with FIG. 4 can be performed sequentially, in parallel, and in any suitable order.

In operation 402, routine 400 receives, by a service assignment system 102, a request for a transportation service associated with pickup and drop off (PUDO) locations. In operation 404, routine 400 in response to receiving the request, transmits data representing the PUDO locations to one or more AV service provider(s) 316. In operation 406, routine 400 receives, from the AV service provider(s) 316, a proposed navigation plan, for an AV, that includes the PUDO locations. In operation 408, routine 400 determines, by the service assignment system 102, whether the proposed navigation plan received from the AV service provider(s) 316 satisfies one or more trip quality criteria. In operation 410, routine 400 selectively transmits an offer to the AV service provider(s) 316 to perform the transportation service in response to determining whether the proposed navigation plan received from the AV service provider(s) 316 satisfies the one or more trip quality criteria, with the offer comprising the PUDO locations and service quality information corresponding to the one or more trip quality criteria.

FIG. 5 is a block diagram 501 showing one example of a software architecture 502 for a computing device. The software architecture 502 may be used in conjunction with various hardware architectures, for example, as described herein. FIG. 5 is merely a non-limiting example of a software architecture 502, and many other architectures may be implemented to facilitate the functionality described herein. A representative hardware layer 503 is illustrated and can represent, for example, any of the above-referenced computing devices. In some examples, the hardware layer 503 may be implemented according to a hardware architecture, such as the hardware architecture 600 of FIG. 6 and/or the software architecture 502 of FIG. 5.

The representative hardware layer 503 comprises one or more processing units 504 having associated executable instructions 505. The executable instructions 505 represent the executable instructions of the software architecture 502, including implementation of the methods, modules, components, and so forth of FIG. 1 to FIG. 3. The hardware layer 503 also includes memory and/or storage modules 506, which also have the executable instructions 505. The hardware layer 503 may also comprise other hardware 507, which represents any other hardware of the hardware layer 503, such as the other hardware illustrated as part of the hardware architecture 600.

In the example architecture of FIG. 5, the software architecture 502 may be conceptualized as a stack of layers where each layer provides particular functionality. For example, the software architecture 502 may include layers such as an operating system 508, libraries 509, middleware layer 510, applications 511, and a presentation layer 523. Operationally, the applications 511 and/or other components within the layers may invoke application programming interface (API) calls 513 through the software stack and receive a response, returned values, and so forth illustrated as messages 514 in response to the API calls 512. The layers illustrated are representative in nature, and not all software architectures have all layers. For example, some mobile or special-purpose operating systems may not provide a middleware layer 510, while others may provide such a layer. Other software architectures may include additional or different layers.

The operating system 508 may manage hardware resources and provide common services. The operating system 508 may include, for example, a kernel 515, services 516, and drivers 517. The kernel 515 may act as an abstraction layer between the hardware and the other software layers. For example, the kernel 515 may be responsible for memory management, processor management (e.g., scheduling), component management, networking, security settings, and so on. The services 516 may provide other common services for the other software layers. In some examples, the services 516 include an interrupt service. The interrupt service may detect the receipt of a hardware or software interrupt and, in response, cause the software architecture 502 to pause its current processing and execute an interrupt service routine (ISR) when an interrupt is received. The ISR may generate an alert.

The drivers 517 may be responsible for controlling or interfacing with the underlying hardware. For instance, the drivers 517 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 509 may provide a common infrastructure that may be used by the applications 511 and/or other components and/or layers. The libraries 509 typically provide functionality that allows other software modules to perform tasks in an easier fashion than by interfacing directly with the underlying operating system 508 functionality (e.g., kernel 515, services 516, and/or drivers 517). The libraries 509 may include system libraries 518 (e.g., C standard library) that may provide functions such as memory allocation functions, string manipulation functions, mathematic functions, and the like. In addition, the libraries 509 may include API libraries 519 such as media libraries (e.g., libraries to support presentation and manipulation of various media formats such as MPEG4, H.264, MP3, AAC, AMR, JPG, and PNG), graphics libraries (e.g., an OpenGL framework that may be used to render user interface and 3D graphic content on a display), database libraries (e.g., SQLite that may provide various relational database functions), web libraries (e.g., WebKit that may provide web browsing functionality), and the like. The libraries 509 may also include a wide variety of other libraries 520 to provide many other APIs to the applications 511 and other software components/modules.

The middleware layer 510 (also sometimes referred to as frameworks) may provide a higher-level common infrastructure that may be used by the applications 511 and/or other software components/modules. For example, the middleware layer 510 may provide various graphical user interface (GUI) functions, high-level resource management, high-level location services, and so forth. The middleware layer 510 may provide a broad spectrum of other APIs that may be used by the applications 511 and/or other software components/modules, some of which may be specific to a particular operating system or platform.

The applications 511 include built-in applications 521 and/or third-party applications 522. Examples of representative built-in applications 521 may include, but are not limited to, a contacts application, a browser application, a book reader application, a location application, a media application, a messaging application, and/or a game application. The third-party applications 522 may include any of the built-in applications 521 as well as a broad assortment of other applications. In a specific example, the third-party applications 522 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party applications 522 may invoke the API calls 512 provided by the mobile operating system such as the operating system 508 to facilitate functionality described herein.

The applications 511 may use built-in operating system functions (e.g., kernel 515, services 516, and/or drivers 517), libraries (e.g., system libraries 518, API libraries 519, and other libraries 520), or middleware layer 510 to create user interfaces to interact with users of the system. Alternatively, or additionally, in some systems, interactions with a user may occur through a presentation layer, such as the presentation layer 523. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 5, this is illustrated by a virtual machine 525. A virtual machine creates a software environment where applications/modules can execute as if they were executing on a hardware computing device. The virtual machine 525 is hosted by a host operating system (e.g., the operating system 508) and typically, although not always, has a virtual machine monitor 524, which manages the operation of the virtual machine 525 as well as the interface with the host operating system (e.g., the operating system 508). A software architecture executes within the virtual machine 525, such as an operating system 526, libraries 527, frameworks/middleware 528, applications 529, and/or a presentation layer 530. These layers of software architecture executing within the virtual machine 525 can be the same as corresponding layers previously described or may be different.

FIG. 6 is a block diagram illustrating a hardware architecture 600 of an example computing device, within which a set or sequence of instructions can be executed to cause a machine to perform examples of any one of the methodologies discussed herein. The hardware architecture 600 describes a computing device for executing the vehicle autonomy system, described herein.

The hardware architecture 600 may operate as a standalone device or may be connected (e.g., networked) to other machines. In a networked deployment, the hardware architecture 600 may operate in the capacity of either a server or a client machine in server-client network environments, or it may act as a peer machine in peer-to-peer (or distributed) network environments. The hardware architecture 600 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example hardware architecture 600 includes a processor unit 602 comprising at least one processor (e.g., a central processing unit (CPU), a graphics processing unit (GPU), or both, processor cores, compute nodes). The hardware architecture 600 may further comprise a main memory 604 and a static memory 606, which communicate with each other via a link 608 (e.g., a bus). The hardware architecture 600 can further include a video display unit 610, an input device 612 (e.g., a keyboard), and a UI navigation device 614 (e.g., a mouse). In some examples, the video display unit 610, input device 612, and UI navigation device 614 are incorporated into a touchscreen display. The hardware architecture 600 may additionally include a storage device 616 (e.g., a drive unit), a signal generation device 618 (e.g., a speaker), a network interface device 620, and one or more sensors (not shown), such as a Global Positioning System (GPS) sensor, compass, accelerometer, or other sensor.

In some examples, the processor unit 602 or another suitable hardware component may support a hardware interrupt. In response to a hardware interrupt, the processor unit 602 may pause its processing and execute an ISR, for example, as described herein.

The storage device 616 includes a machine-readable medium 622 on which is stored one or more sets of data structures and instructions 624 (e.g., software) embodying or used by any one or more of the methodologies or functions described herein. The instructions 624 can also reside, completely or at least partially, within the main memory 604, within the static memory 606, and/or within the processor unit 602 during execution thereof by the hardware architecture 600, with the main memory 604, the static memory 606, and the processor unit 602 also constituting machine-readable media.

### Executable Instructions and Machine-Storage Medium

The various memories (i.e., main memory 604, static memory 606, and/or memory of the processor units 602) and/or the storage device 616 may store one or more sets of instructions and data structures (e.g., the instructions 624) embodying or used by any one or more of the methodologies or functions described herein. These instructions, when executed by the processor unit(s), cause various operations to implement the disclosed examples.

As used herein, the terms “machine-storage medium,” “device-storage medium,” and “computer-storage medium” (referred to collectively as “machine-storage medium”) mean the same thing and may be used interchangeably. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium” and “device-readable medium” mean the same thing and may be used interchangeably in this disclosure. The terms are defined to include both non-transitory machine-storage media and signal media. Thus, the terms include both storage devices/media and carrier waves/modulated data signals.

The instructions 624 can further be transmitted or received over a communications network 626 using a transmission medium via the network interface device 620 using any one of a number of well-known transfer protocols (e.g., Hypertext Transfer Protocol (HTTP)). Examples of communication networks include a local area network (LAN), a wide area network (WAN), the Internet, mobile telephone networks, plain old telephone service (POTS) networks, and wireless data networks (e.g., Wi-Fi, 3G, 4G Long-Term Evolution (LTE)/LTE-A, 5G, or WiMAX networks).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

In view of the disclosure above, various examples are set forth below. It should be noted that one or more features of an example, taken in isolation or combination, should be considered within the disclosure of this application.

Example 1. A method comprising: receiving, by a service assignment system, a request for a transportation service associated with pickup and drop off (PUDO) locations; in response to receiving the request, transmitting data representing the PUDO locations to an autonomous vehicle (AV) service provider; receiving, from the AV service provider, a proposed navigation plan, for an AV, that includes the PUDO locations; determining, by the service assignment system, whether the proposed navigation plan received from the AV service provider satisfies one or more trip quality criteria; and selectively transmitting an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.

Example 2. The method of Example 1, wherein the data is transmitted as part of a pre-offer check operation, wherein the AV service provider attempts to generate a route for completing the transportation service based on the service quality information, comprising: receiving, from the AV service provider, data indicating whether the AV service provider accepts or rejects the offer.

Example 3. The method of Example 2, further comprising: receiving a rejection of the offer from the AV service provider in response to the AV service provider being unsuccessful in generating the route for completing the transportation service.

Example 4. The method of any one of Examples 2-3, further comprising: processing data associated with the rejection to infer a reason for the rejection of the offer.

Example 5. The method of any one of Examples 2-4, further comprising: receiving, from the AV service provider, a reason for rejection of the offer.

Example 6. The method of Example 5, further comprising: determining whether the transportation service corresponds to mobility of a rider or delivery of an item; and selectively transmitting one or more further offers for completing the transportation service based on determining whether the transportation service corresponds to the mobility of the rider or the delivery of the item.

Example 7. The method of any one of Examples 5-6, wherein the AV service provider selects the reason from a plurality of available reasons provided by the service assignment system, the plurality of available reasons comprising one or more of: an operational design domain indicating lack of capability by the AV to complete the transportation service; a change in a state associated with the AV between a time that the data was transmitted to the AV service provider and a time when the offer was transmitted to the AV service provider; a malfunction of the AV; an estimated time of arrival (ETA) of the AV at one of the PUDO locations exceeds an expected ETA by more than a threshold duration; an estimated time of departure (ETD) of the AV exceeds a threshold; a distance between a pickup or drop off location of the route exceeds a pickup or drop off location requested by the transportation service by more than a threshold distance; out of service area for the AV; end time of the route exceeds operating hours of the AV; and unsupported weather or road conditions.

Example 8. The method of any one of Examples 5-7, further comprising: categorizing the reason for the rejection as being applicable to a fleet of AVs or specific to the AV in a fleet of AVs of the AV service provider.

Example 9. The method of Example 8, further comprising: determining that the reason for rejection is applicable to the fleet of AVs associated with the AV service provider; and preventing transmission of one or more further offers for completing the transportation service to the AV service provider.

Example 10. The method of Example 9, further comprising: selecting an alternate AV service provider; and transmitting the one or more further offers to the alternate service provider in response to determining that the reason for rejection is applicable to the fleet of AVs associated with the AV service provider.

Example 11. The method of Example 8, further comprising: determining that the reason for rejection is specific to the AV in the fleet of AVs of the AV service provider; and in response to determining that the reason for rejection is specific to the AV in the fleet of AVs of the AV service provider, transmitting one or more further offers to the AV service provider, the one or more further offers having a revised set of the one or more trip quality criteria for completing the transportation service.

Example 12. The method of any one of Examples 2-11, further comprising: receiving an acceptance of the offer from the AV service provider in response to the AV service provider successfully generating the route for completing the transportation service.

Example 13. The method of Example 12, further comprising: checking, by the service assignment system, the route, generated by the AV service provider, to ensure the route satisfies the one or more trip quality criteria.

Example 14. The method of any one of Examples 1-13, wherein the data representing the PUDO locations comprises a requested pickup location and a requested drop off location, and wherein determining, by the service assignment system, whether the proposed navigation plan received from the AV service provider satisfies one or more trip quality criteria comprises: computing a first deviation of distance between the requested pickup location and a proposed pickup location in the proposed navigation plan; computing a second deviation of duration between an expected estimated time of arrival (ETA) at the requested pickup location and a proposed ETA at the requested pickup location in the proposed navigation plan; computing a third deviation of distance between the requested drop off location and a proposed drop off location in the proposed navigation plan; computing a fourth deviation of duration between an expected ETA at the drop off location and a proposed ETA at the drop off location in the proposed navigation plan; and determining that the one or more trip quality criteria is satisfied in response to determining that the first deviation and the third deviation fail to transgress a maximum distance threshold and in response to determining that the second deviation and the fourth deviation fail to transgress a maximum duration threshold.

Example 15. The method of any one of Examples 1-14, wherein the service quality information corresponding to the one or more trip quality criteria included in the offer comprises an expected estimated time of arrival (ETA) at a requested pickup location and an expected ETA at a drop off location, wherein the service quality information comprises a first maximum distance threshold between the requested pickup location and a pickup location in a route performed by the AV, and wherein the service quality information comprises a second maximum distance threshold between the requested drop off location and a drop off location in the route performed by the AV.

Example 16. The method of any one of Examples 1-15, further comprising: applying a first set of filters to a collection of vehicles comprising one or more AVs prior to transmitting the data representing the PUDO locations to the AV service provider.

Example 17. The method of any one of Examples 1-16, further comprising: preventing transmission of the offer to the AV service provider in response to determining that the proposed navigation plan received from the AV service provider fails to satisfy the one or more trip quality criteria.

Example 18. The method of any one of Examples 1-17, further comprising: obtaining a profile associated with a rider corresponding to the request; predicting whether the rider is likely to accept transportation services from the AV based on the profile; and selectively transmitting the offer in response to the predicting of whether the rider is likely to accept transportation services from the AV.

Example 19. A system comprising: at least one processor; and a memory storing instructions that, when executed by the at least one processor, configure the apparatus to perform operations comprising: receiving, by a service assignment system, a request for a transportation service associated with pickup and drop off (PUDO) locations; in response to receiving the request, transmitting data representing the PUDO locations to an autonomous vehicle (AV) service provider; receiving, from the AV service provider, a proposed navigation plan, for an AV, that includes the PUDO locations; determining, by the service assignment system, whether the proposed navigation plan received from the AV service provider satisfies one or more trip quality criteria; and selectively transmitting an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.

Example 20. A non-transitory computer-readable storage medium, the computer-readable storage medium including instructions that when executed by a computer, cause the computer to perform operations comprising: receiving, by a service assignment system, a request for a transportation service associated with pickup and drop off (PUDO) locations; in response to receiving the request, transmitting data representing the PUDO locations to an autonomous vehicle (AV) service provider; receiving, from the AV service provider, a proposed navigation plan, for an AV, that includes the PUDO locations; determining, by the service assignment system, whether the proposed navigation plan received from the AV service provider satisfies one or more trip quality criteria; and selectively transmitting an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.

What is claimed is:

1. A method comprising:
receiving, by a service assignment system, a request for a transportation service associated with pickup and drop off (PUDO) locations;
in response to receiving the request, transmitting data representing the PUDO locations to an autonomous vehicle (AV) service provider;
receiving, from the AV service provider, a proposed navigation plan, for an AV, that includes the PUDO locations;
determining, by the service assignment system, whether the proposed navigation plan received from the AV service provider satisfies one or more trip quality criteria; and
selectively transmitting an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.

2. The method of claim 1, wherein the data is transmitted as part of a pre-offer check operation, wherein the AV service provider attempts to generate an individual navigation plan for completing the transportation service based on the service quality information, comprising:
receiving, from the AV service provider, data indicating whether the AV service provider accepts or rejects the offer.

3. The method of claim 2, further comprising:
receiving a rejection of the offer from the AV service provider in response to the AV service provider being unsuccessful in generating the individual navigation plan for completing the transportation service.

4. The method of claim 2, further comprising:
processing data associated with the rejection to infer a reason for the rejection of the offer.

5. The method of claim 2, further comprising:
receiving, from the AV service provider, a reason for rejection of the offer.

6. The method of claim 5, further comprising:
determining whether the transportation service corresponds to mobility of a rider or delivery of an item; and
selectively transmitting one or more further offers for completing the transportation service based on determining whether the transportation service corresponds to the mobility of the rider or the delivery of the item.

7. The method of claim 5, wherein the AV service provider selects the reason from a plurality of available reasons provided by the service assignment system, the plurality of available reasons comprising one or more of:
an operational design domain indicating lack of capability by the AV to complete the transportation service;
a change in a state associated with the AV between a time that the data was transmitted to the AV service provider and a time when the offer was transmitted to the AV service provider;
a malfunction of the AV;
an estimated time of arrival (ETA) of the AV at one of the PUDO locations exceeds an expected ETA by more than a threshold duration;
an estimated time of departure (ETD) of the AV exceeds a threshold;
a distance between a pickup or drop off location of the individual navigation plan exceeds a pickup or drop off location requested by the transportation service by more than a threshold distance;
out of service area for the AV;
end time of the individual navigation plan exceeds operating hours of the AV; and
unsupported weather or road conditions.

8. The method of claim 5, further comprising:
categorizing the reason for the rejection as being applicable to a fleet of AVs or specific to the AV in a fleet of AVs of the AV service provider.

9. The method of claim 8, further comprising:
determining that the reason for rejection is applicable to the fleet of AVs associated with the AV service provider; and
preventing transmission of one or more further offers for completing the transportation service to the AV service provider.

10. The method of claim 9, further comprising:
selecting an alternate AV service provider; and
transmitting the one or more further offers to the alternate service provider in response to determining that the reason for rejection is applicable to the fleet of AVs associated with the AV service provider.

11. The method of claim 8, further comprising:
determining that the reason for rejection is specific to the AV in the fleet of AVs of the AV service provider; and
in response to determining that the reason for rejection is specific to the AV in the fleet of AVs of the AV service provider, transmitting one or more further offers to the AV service provider, the one or more further offers having a revised set of the one or more trip quality criteria for completing the transportation service.

12. The method of claim 2, further comprising:
receiving an acceptance of the offer from the AV service provider in response to the AV service provider successfully generating the individual navigation plan for completing the transportation service.

13. The method of claim 12, further comprising:
checking, by the service assignment system, the individual navigation plan, generated by the AV service provider, to ensure the individual navigation plan satisfies the one or more trip quality criteria.

14. The method of claim 1, wherein the data representing the PUDO locations comprises a requested pickup location and a requested drop off location, and wherein determining, by the service assignment system, whether the proposed navigation plan received from the AV service provider satisfies one or more trip quality criteria comprises:
computing a first deviation of distance between the requested pickup location and a proposed pickup location in the proposed navigation plan;
computing a second deviation of duration between an expected estimated time of arrival (ETA) at the requested pickup location and a proposed ETA at the requested pickup location in the proposed navigation plan;
computing a third deviation of distance between the requested drop off location and a proposed drop off location in the proposed navigation plan;
computing a fourth deviation of duration between an expected ETA at the drop off location and a proposed ETA at the drop off location in the proposed navigation plan; and
determining that the one or more trip quality criteria is satisfied in response to determining that the first deviation and the third deviation fail to transgress a maximum distance threshold and in response to determining that the second deviation and the fourth deviation fail to transgress a maximum duration threshold.

15. The method of claim 1, wherein the service quality information corresponding to the one or more trip quality criteria included in the offer comprises an expected estimated time of arrival (ETA) at a requested pickup location and an expected ETA at a drop off location, wherein the service quality information comprises a first maximum distance threshold between the requested pickup location and a pickup location in a individual navigation plan performed by the AV, and wherein the service quality information comprises a second maximum distance threshold between the requested drop off location and a drop off location in the individual navigation plan performed by the AV.

16. The method of claim 1, further comprising:
applying a first set of filters to a collection of vehicles comprising one or more AVs prior to transmitting the data representing the PUDO locations to the AV service provider.

17. The method of claim 1, further comprising:
preventing transmission of the offer to the AV service provider in response to determining that the proposed navigation plan received from the AV service provider fails to satisfy the one or more trip quality criteria.

18. The method of claim 1, further comprising:
obtaining a profile associated with a rider corresponding to the request;
predicting whether the rider is likely to accept transportation services from the AV based on the profile; and
selectively transmitting the offer in response to the predicting of whether the rider is likely to accept transportation services from the AV.

19. A system comprising:
at least one processor; and
a memory storing instructions that, when executed by the at least one processor, configure the system to perform operations comprising:
receiving, by a service assignment system, a request for a transportation service associated with pickup and drop off (PUDO) locations;
in response to receiving the request, transmitting data representing the PUDO locations to an autonomous vehicle (AV) service provider;
receiving, from the AV service provider, a proposed navigation plan, for an AV, that includes the PUDO locations;
determining, by the service assignment system, whether the proposed navigation plan received from the AV service provider satisfies one or more trip quality criteria; and
selectively transmitting an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.

20. A non-transitory computer-readable storage medium, the computer-readable storage medium including instructions that when executed by a computer, cause the computer to perform operations comprising:
receiving, by a service assignment system, a request for a transportation service associated with pickup and drop off (PUDO) locations;
in response to receiving the request, transmitting data representing the PUDO locations to an autonomous vehicle (AV) service provider;
receiving, from the AV service provider, a proposed navigation plan, for an AV, that includes the PUDO locations;
determining, by the service assignment system, whether the proposed navigation plan received from the AV service provider satisfies one or more trip quality criteria; and
selectively transmitting an offer to the AV service provider to perform the transportation service in response to determining whether the proposed navigation plan received from the AV service provider satisfies the one or more trip quality criteria, the offer comprising the PUDO locations and service quality information corresponding to the one or more trip quality criteria.
